(19) United States
(12) Patent Application Publication
(10) Pub. No.: US 2015/0362623 A1
(43) Pub. Date: Dec. 17, 2015

(54) JOINT INVERSION OF ATTRIBUTES

(71) Applicant: WesternGeco, LLC, Houston, TX (US)

(72) Inventors: Fabio Marco Miotti, Milan (IT); Jeremie Giraud, Milan (IT)

(21) Appl. No.: 14/732,196

(22) Filed: Jun. 5, 2015

Related U.S. Application Data
(60) Provisional application No. 62/011,344, filed on Jun. 12, 2014.

(51) Int. Cl. G01V 99/00; G01V 7/00; G01V 3/02; G01V 1/28; G01V 3/08

(52) U.S. Cl. CPC G01V 99/005; G01V 1/282; G01V 1/284; G01V 3/08; G01V 3/02; G01V 7/00; G01V 1/38

(57) ABSTRACT

A method can include receiving data associated with a multilithology geologic environment; and, based on at least a portion of the data, determining values for multiphase model parameters defined in a model space.

### BACKGROUND

Seismic interpretation is a process that may examine seismic data (e.g., location and time or depth) in an effort to identify subsurface structures such as horizons and faults. Structures may be, for example, faulted stratigraphic formations indicative of hydrocarbon traps or flow channels. In the field of resource extraction, enhancements to seismic interpretation can allow for construction of a more accurate model, which, in turn, may improve seismic volume analysis for purposes of resource extraction. Various techniques described herein pertain to processing of seismic data and optionally one or more other types of data, for example, for analysis of such data to characterize one or more regions in a geologic environment and, for example, to perform one or more operations (e.g., field operations, etc.).

### SUMMARY

A method can include receiving data associated with a multilithology geologic environment; and, based on at least a portion of the data, determining values for multiphase model parameters defined in a model space. A system can include a processor; memory operatively coupled to the processor; and one or more modules that include processor-executable instructions stored in the memory to instruct the system to receive data associated with a multilithology geologic environment; and, based on at least a portion of the data, determine values for multiphase model parameters defined in a model space. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment and various equipment associated with the geologic environment;

FIG. 2 illustrates an example of a sedimentary basin, an example of a method, an example of a formation, an example of a borehole, an example of a borehole tool, an example of a convention and an example of a system;

FIG. 3 illustrates an example of a technique that may acquire data;

FIG. 4 illustrates an example of a system;

FIG. 5 illustrates an example of a system;

FIG. 6 illustrates an example of a geologic environment;

FIG. 7 illustrates an example of a method;

FIG. 8 illustrates an example of information associated with shale and sand (e.g., sandstone, etc.);

FIG. 9 illustrates an example of links for data and properties via constitutive equations where properties can include cross properties;

FIG. 10 illustrates an example of a model with associated data;

FIG. 11 illustrates an example of a method; and

FIG. 12 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

In various instances, an analysis may include creating velocity models, for example, for Pre-Stack Depth Migration (PSDM) of data and/or other tasks. As an example, creation of a velocity model may include implementation of joint inversion (JI) of seismic, gravity (e.g., where gravity may include any type of scalar and/or vectorial gravity measurements and derived quantities such as: gravity field measurements, gradient measurements, Bouguer anomaly, etc.), and electromagnetic data (e.g., magnetotelluric (MT) and/or Controlled-Source Electromagnetic (CSEM), where controlled-source electromagnetic may include one or more types of geophysical exploration methods based on electromagnetic induction in the earth, measured and/or computed in frequency or time domains).

An estimated seismic velocity model can assist with depth imaging through migration; noting that inaccuracies in a seismic velocity model can cause, for example, lateral and vertical mispositioning of reflectors in depth. Mispositioning of structure can impact exploration of hydrocarbons, for example, by increasing risk of drilling dry wells, by misidentifying oil and gas-bearing structures, etc.

As an example, a workflow that integrates multiple physical measurements can produce output(s) that may assist with building an earth model. For example, consider a model that includes representations of structures, which may include one or more reservoirs. As an example, a method may include integration of seismic and nonseismic data. As an example, JI may be implemented in a manner that can allow for integration of different geophysical datasets. Such an approach may act to reduce uncertainty in interpretation.

A JI approach may prove useful in subsalt, subbasalt, and subthrust areas, where seismic imaging can face issues, for example, as deep illumination may be limited. In such cases, JI may be used in a framework of a depth imaging workflow that can provide extended capabilities for resolving complex velocity fields, for example, under conditions of poor signal-to-noise ratio.

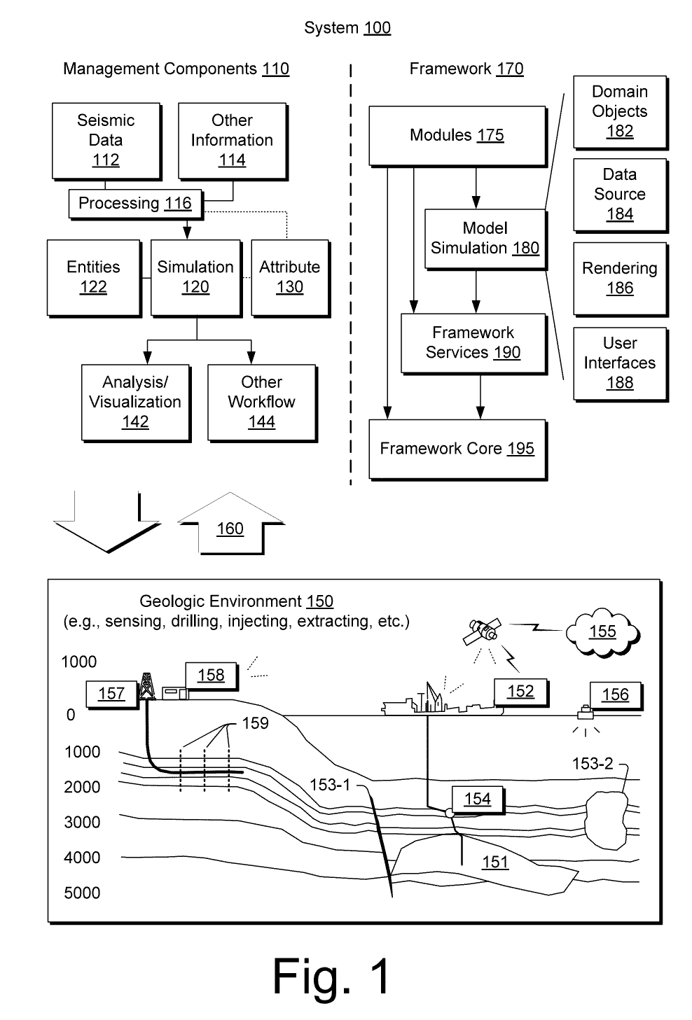

FIG. 1 shows an example of a system 100 that includes various management components 110 to manage various aspects of a geologic environment 150 (e.g., an environment that includes a sedimentary basin, a reservoir 151, one or more fractures 153, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, seismic data may be processed using a framework such as the OMEGA® framework (Schlumberger Limited, Houston, Tex.). The OMEGA® framework provides features that can be implemented for processing of seismic data, for example, through prestack seismic interpretation and seismic inversion. A framework may be scalable such that it enables processing and imaging on a single workstation, on a massive compute cluster, etc. As an example, one or more techniques, technologies, etc. described herein may optionally be implemented in conjunction with a framework such as, for example, the OMEGA® framework.

A framework for processing data may include features for 2D line and 3D seismic surveys. Modules for processing seismic data may include features for prestack seismic interpretation (PSI), optionally pluggable into a framework such as the OCEAN® framework. A workflow may be specified to include processing via one or more frameworks, plug-ins, add-ons, etc. A workflow may include quantitative interpretation, which may include performing pre- and poststack seismic data conditioning, inversion (e.g., seismic to properties and properties to synthetic seismic), wedge modeling for thin-bed analysis, amplitude versus offset (AVO) and amplitude versus angle (AVA) analysis, reconnaissance, etc. As an example, a workflow may aim to output rock properties based at least in part on processing of seismic data. As an example, various types of data may be processed to provide one or more models (e.g., earth models). For example, consider processing of one or more of seismic data, well data, electromagnetic and magnetic telluric data, reservoir data, etc.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as a fault 153-1, a geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

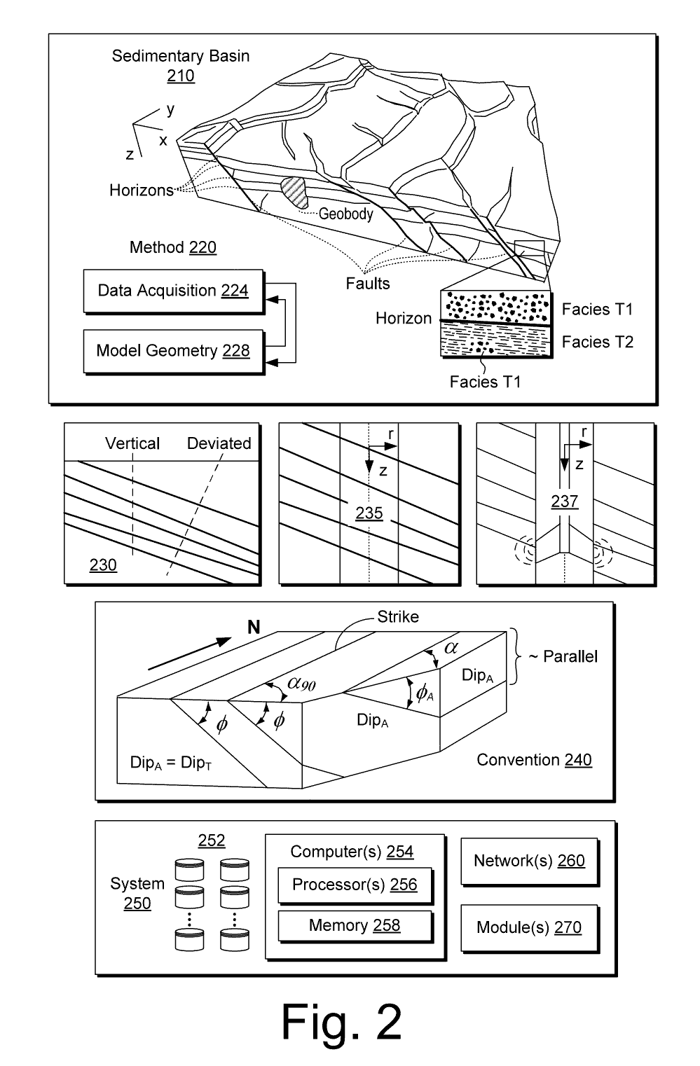

FIG. 2 shows an example of a sedimentary basin 210 (e.g., a geologic environment), an example of a method 220 for model building (e.g., for a simulator, etc.), an example of a formation 230, an example of a borehole 235 in a formation, an example of a convention 240 and an example of a system 250.

As an example, reservoir simulation, petroleum systems modeling, etc. may be applied to characterize various types of subsurface environments, including environments such as those of FIG. 1.

In FIG. 2, the sedimentary basin 210, which is a geologic environment, includes horizons, faults, one or more geobodies and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of geological processes, data may be provided, for example, data such as geochemical data (e.g., temperature, kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

In basin and petroleum systems modeling, quantities such as temperature, pressure and porosity distributions within the sediments may be modeled, for example, by solving partial differential equations (PDEs) using one or more numerical techniques. Modeling may also model geometry with respect to time, for example, to account for changes stemming from geological events (e.g., deposition of material, erosion of material, shifting of material, etc.).

A commercially available modeling framework marketed as the PETROMOD® framework (Schlumberger Limited, Houston, Tex.) includes features for input of various types of information (e.g., seismic, well, geological, etc.) to model evolution of a sedimentary basin. The PETROMOD® framework provides for petroleum systems modeling via input of various data such as seismic data, well data and other geological data, for example, to model evolution of a sedimentary basin. The PETROMOD® framework may predict if, and how, a reservoir has been charged with hydrocarbons, including, for example, the source and timing of hydrocarbon generation, migration routes, quantities, pore pressure and hydrocarbon type in the subsurface or at surface conditions. In combination with a framework such as the PETREL® framework, workflows may be constructed to provide basin-to-prospect scale exploration solutions. Data exchange between frameworks can facilitate construction of models, analysis of data (e.g., PETROMOD® framework data analyzed using PETREL® framework capabilities), and coupling of workflows.

As shown in FIG. 2, the formation 230 includes a horizontal surface and various subsurface layers. As an example, a borehole may be vertical. As another example, a borehole may be deviated. In the example of FIG. 2, the borehole 235 may be considered a vertical borehole, for example, where the z-axis extends downwardly normal to the horizontal surface of the formation 230. As an example, a tool 237 may be positioned in a borehole, for example, to acquire information. As mentioned, a borehole tool may be configured to acquire electrical borehole images. As an example, the fullbore Formation Microlmager (FMI) tool (Schlumberger Limited, Houston, Tex.) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, a borehole may be vertical, deviate and/or horizontal. As an example, a tool may be positioned to acquire information in a horizontal portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the TECHLOG® framework.

As to the convention 240 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 240 of FIG. 2, various angles φ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 2 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 240 of FIG. 2). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 240 of FIG. 2). Apparent dip may be the dip of a plane as measured in any other direction except in the direction of true dip (see, e.g., φ_{A} as Dip_{A} for angle α); however, it is possible that the apparent dip is equal to the true dip (see, e.g., φ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 240 of FIG. 2, the dip of a plane as seen in a cross-section perpendicular to the strike is true dip (see, e.g., the surface with φ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 240 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 240 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.). As an example, dip may change spatially as a layer approaches a geobody. For example, consider a salt body that may rise due to various forces (e.g., buoyancy, etc.). In such an example, dip may trend upward as a salt body moves upward.

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As an example, equations may be provided for petroleum expulsion and migration, which may be modeled and simulated, for example, with respect to a period of time. Petroleum migration from a source material (e.g., primary migration or expulsion) may include use of a saturation model where migration-saturation values control expulsion. Determinations as to secondary migration of petroleum (e.g., oil or gas), may include using hydrodynamic potential of fluid and accounting for driving forces that promote fluid flow. Such forces can include buoyancy gradient, pore pressure gradient, and capillary pressure gradient.

As shown in FIG. 2, the system 250 includes one or more information storage devices 252, one or more computers 254, one or more networks 260 and one or more modules 270. As to the one or more computers 254, each computer may include one or more processors (e.g., or processing cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252.

As an example, the one or more modules 270 may include instructions (e.g., stored in memory) executable by one or more processors to instruct the system 250 to perform various actions. As an example, the system 250 may be configured such that the one or more modules 270 provide for establishing the framework 170 of FIG. 1 or a portion thereof. As an example, one or more methods, techniques, etc. may be performed using one or more modules, which may be, for example, one or more of the one or more modules 270 of FIG. 2.

As mentioned, seismic data may be acquired and analyzed to understand better subsurface structure of a geologic environment. Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less that 1 Hz and/or optionally more than 100 Hz). Seismic data may be processed and interpreted, for example, to understand better composition, fluid content, extent and geometry of subsurface rocks.

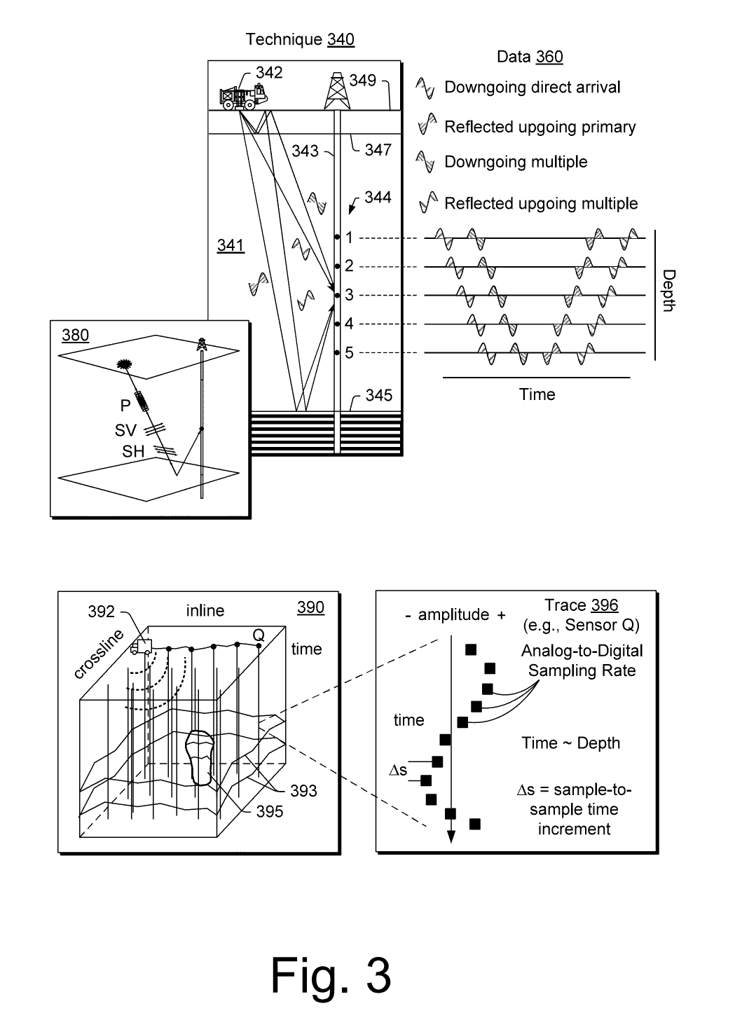

FIG. 3 shows an example of an acquisition technique 340 to acquire seismic data (see, e.g., data 360). As an example, a system may process data acquired by the technique 340, for example, to allow for direct or indirect management of sensing, drilling, injecting, extracting, etc., with respect to a geologic environment. In turn, further information about the geologic environment may become available as feedback (e.g., optionally as input to the system). As an example, an operation may pertain to a reservoir that exists in a geologic environment such as, for example, a reservoir. As an example, a technique may provide information (e.g., as an output) that may specifies one or more location coordinates of a feature in a geologic environment, one or more characteristics of a feature in a geologic environment, etc.

In FIG. 3, the technique 340 may be implemented with respect to a geologic environment 341. As shown, an energy source (e.g., a transmitter) 342 may emit energy where the energy travels as waves that interact with the geologic environment 341. As an example, the geologic environment 341 may include a bore 343 where one or more sensors (e.g., receivers) 344 may be positioned in the bore 343. As an example, energy emitted by the energy source 342 may interact with a layer (e.g., a structure, an interface, etc.) 345 in the geologic environment 341 such that a portion of the energy is reflected, which may then be sensed by one or more of the sensors 344. Such energy may be reflected as an upgoing primary wave (e.g., or “primary” or “singly” reflected wave). As an example, a portion of emitted energy may be reflected by more than one structure in the geologic environment and referred to as a multiple reflected wave (e.g., or “multiple”). For example, the geologic environment 341 is shown as including a layer 347 that resides below a surface layer 349. Given such an environment and arrangement of the source 342 and the one or more sensors 344, energy may be sensed as being associated with particular types of waves.

As an example, a “multiple” may refer to multiply reflected seismic energy or, for example, an event in seismic data that has incurred more than one reflection in its travel path. As an example, depending on a time delay from a primary event with which a multiple may be associated, a multiple may be characterized as a short-path or a peg-leg, for example, which may imply that a multiple may interfere with a primary reflection, or long-path, for example, where a multiple may appear as a separate event. As an example, seismic data may include evidence of an interbed multiple from bed interfaces, evidence of a multiple from a water interface (e.g., an interface of a base of water and rock or sediment beneath it) or evidence of a multiple from an air-water interface, etc.

As shown in FIG. 3, the acquired data 360 can include data associated with downgoing direct arrival waves, reflected upgoing primary waves, downgoing multiple reflected waves and reflected upgoing multiple reflected waves. The acquired data 360 is also shown along a time axis and a depth axis. As indicated, in a manner dependent at least in part on characteristics of media in the geologic environment 341, waves travel at velocities over distances such that relationships may exist between time and space. Thus, time information, as associated with sensed energy, may allow for understanding spatial relations of layers, interfaces, structures, etc. in a geologic environment.

FIG. 3 also shows a diagram 380 that illustrates various types of waves as including P, SV an SH waves. As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by a seismic energy sources (e.g., other than an air gun). As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by crossplotting P-wave and S-wave velocities, and/or by other techniques.

As an example of parameters that may characterize anisotropy of media (e.g., seismic anisotropy), consider the Thomsen parameters ε, δ and γ. The Thomsen parameter δ describes depth mismatch between logs (e.g., actual depth) and seismic depth. As to the Thomsen parameter ε, it describes a difference between vertical and horizontal compressional waves (e.g., P or P-wave or quasi compressional wave qP or qP-wave). As to the Thomsen parameter γ, it describes a difference between horizontally polarized and vertically polarized shear waves (e.g., horizontal shear wave SH or SH-wave and vertical shear wave SV or SV-wave or quasi vertical shear wave qSV or qSV-wave). Thus, the Thomsen parameters ε and γ may be estimated from wave data while estimation of the Thomsen parameter δ may involve access to additional information.

In the example of FIG. 3, a diagram 390 shows acquisition equipment 392 emitting energy from a source (e.g., a transmitter) and receiving reflected energy via one or more sensors (e.g., receivers) strung along an inline direction. As the region includes layers 393 and, for example, the geobody 395, energy emitted by a transmitter of the acquisition equipment 392 can reflect off the layers 393 and the geobody 395. Evidence of such reflections may be found in the acquired traces. As to the portion of a trace 396, energy received may be discretized by an analog-to-digital converter that operates at a sampling rate. For example, the acquisition equipment 392 may convert energy signals sensed by sensor Q to digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

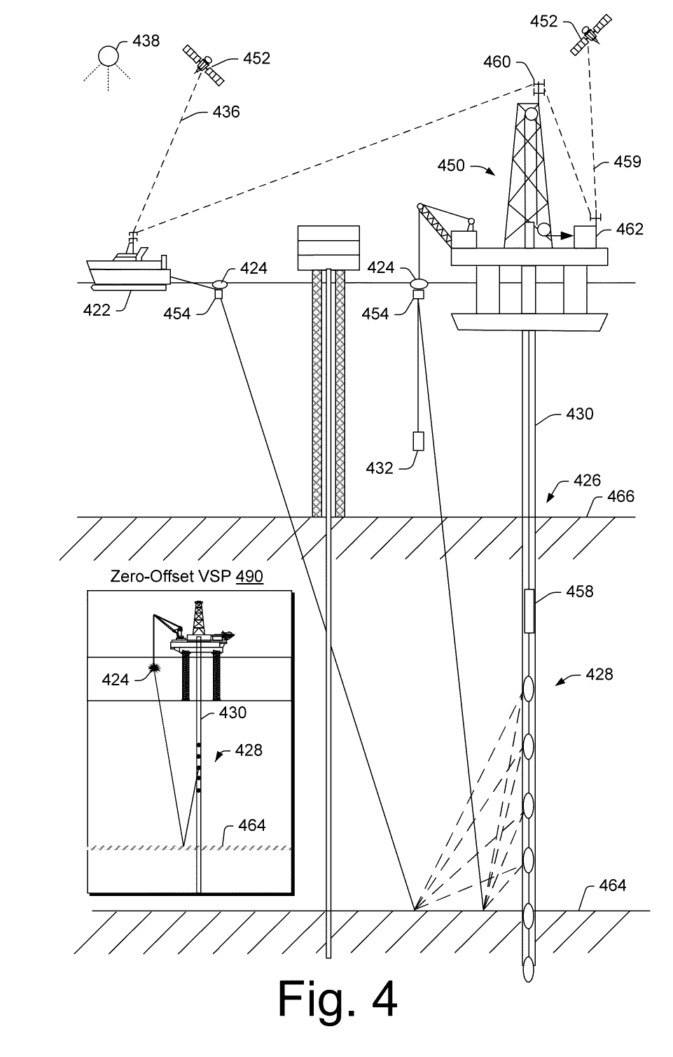

FIG. 4 shows an example of a system 420 in which one or more vessels 422 may be employed to enable seismic profiling, e.g., three-dimensional vertical seismic profiling (VSP) or rig/offset vertical seismic profiling (VSP). In the example of FIG. 4, the system 420 is illustrated as including a rig 450, the vessel 422, and one or more acoustic receivers 428 (e.g., a receiver array). As an example, a vessel may include a source 424 (e.g., or source array) and/or the rig 450 may include a source 424 (e.g., or source array).

As an example, the vessel 422 may travel a path or paths where locations may be recorded through the use of navigation system signals 436. As an example, such signals may be associated with a satellite-based system that includes one or more satellites 452 and 438. As an example, the satellite 438 may be part of a global positioning system (GPS), which may be implemented to record position, speed, direction, and other parameters of the vessel 422. As an example, one or more satellites, communication equipment, etc. may be configured to provide for VSAT communications, VHF communications, UHF communications, etc.

In the example of FIG. 4, the acoustic receivers 428 may be part of a data acquisition system 426, for example, that may be deployed in borehole 430 via one or more of a variety of delivery systems, such as wireline delivery systems, slickline delivery systems, and other suitable delivery systems. As an example, the acoustic receivers 428 may be communicatively coupled with processing equipment 458, which may be positioned at a downhole location. By way of example, processing equipment 458 may include a telemetry system for transmitting data from acoustic receivers 428 to additional processing equipment 462 located at the surface, e.g., on the rig 450 and/or vessels 422. As an example, information acquired may optionally be transmitted (see, e.g., signals 459).

Depending on the specifics of a given data communication system, examples of surface processing equipment 462 may include a radio repeater 460 and/or one or more of a variety of other and/or additional signal transfer components and signal processing components. The radio repeater 460 along with other components of processing equipment 462 may be used to communicate signals, e.g., UHF and/or VHF signals, between vessels (e.g., the vessel 422 and one or more other vessels) and the rig 450, for example, to enable further communication with downhole data acquisition system 426.

As an example, the acoustic receivers 428 may be coupled to the surface processing equipment 462 via one or more wire connections; noting that additionally or alternatively wireless and/or optical connections may be employed.

As an example, the surface processing equipment 462 may include a synchronization unit, for example, to assist with coordination of emissions from one or more sources (e.g., optionally dithered (delayed) source arrays). As an example, coordination may extend to one or more receivers (e.g., consider the acoustic receivers 428 located in borehole 430). As an example, a synchronization unit may use coordinated universal time, optionally employed in cooperation with a global positioning system (e.g., to obtain UTC data from GPS receivers of a GPS system).

FIG. 4 illustrates examples of equipment for performing seismic profiling that can employ simultaneous or near-simultaneous acquisition of seismic data. By way of example, the seismic profiling may include three-dimensional vertical seismic profiling (VSP) but other applications may utilize rig/offset vertical seismic profiling or seismic profiling employing walkaway lines. As an example, an offset source may be provided by the source 424 located on the rig 450, on the vessel 422, and/or on another vessel or structure (e.g., stationary and/or movable from one location to another location).

As an example, a system may employ one or more of various arrangements of a source or sources on a vessel(s) and/or a rig(s). As shown in the example of FIG. 4, the acoustic receivers 428 of downhole acquisition system 426 are configured to receive the source signals, at least some of which are reflected off a reflection boundary 464 located beneath a sea bottom 436. The acoustic receivers 428 may generate data streams that are relayed uphole to a suitable processing system, e.g., the processing system 462.

While the acoustic receivers 428 may generate data streams, a navigation system may determine a real-time speed, position, and direction of the vessel 422 and also estimate initial shot times accomplished via signal generators 454 of the appropriate source 424 (e.g., or source array). A source controller may be part of the surface processing equipment 462 (e.g., located on the rig 450, on the vessel 422, or at other suitable location) and may be configured with circuitry that can control firing of acoustic source generated signals so that the timing of an additional shot time (e.g., optionally a shot time via a slave vessel) may be based on an initial shot time (e.g., a shot time via a master vessel) plus a dither value.

As an example, a synchronization unit of, for example, the surface processing equipment 462, may coordinate firing of dithered acoustic signals with recording of acoustic signals by the downhole acquisition system 426. A processor system may be configured to separate a data stream of the initial shot and a data stream of the additional shot via a coherency filter. As an example, an approach may employ simultaneous acquisition and/or may not perform separation of the data streams. In such cases, the dither may be effectively zero.

After an initial shot time at T=0 (T0) is determined, subsequent firings of acoustic source arrays may be offset by a dither. The dithers may be positive or negative and sometimes created as pre-defined random delays. Use of dithers facilitates the separation of simultaneous or near-simultaneous data sets to simplify the data processing. The ability to have acoustic source arrays fire in simultaneous or near-simultaneous patterns reduces the overall amount of time used for three-dimensional vertical seismic profiling source acquisition. This, in turn, may reduce rig time. As a result, the overall cost of the seismic operation may be reduced, rendering the data intensive process much more accessible.

If acoustic source arrays used in the seismic data acquisition are widely separated, the difference in move-outs across the acoustic receiver array of the wave fields generated by the acoustic sources can be sufficient to obtain a relatively clean data image via processing the data. However, even when acoustic sources are substantially co-located in time, data acquired a method involving dithering of the firing times of the individual sources may be processed to a formation image. For example, consider taking advantage of the incoherence of the data generated by one acoustic source when seen in the reference time of another acoustic source.

Also shown in FIG. 4 is an inset example of a zero-offset vertical seismic profile (VSP) scenario 490. In such an example, an acquisition geometry may be limited to an ability to position equipment that is physically coupled to the rig 450. As shown, for given the acquisition geometry, there may be no substantial offset between the source 424 and bore 430. In such an example, a zero-offset VSP may be acquired where seismic waves travel substantially vertically down to a reflector (e.g., the layer 464) and up to the receiver 428, which may be a receiver array. Where one or more vessels are employed (e.g., the vessel 422), one or more other types of surveys may be performed. As an example, a three-dimensional VSP may be performed using a vessel.

As an example, one or more attribute modules may be provided for processing seismic data. As an example, attributes may include geometrical attributes (e.g., dip angle, azimuth, continuity, seismic trace, etc.). Such attributes may be part of a structural attributes library (see, e.g., the attribute component 130 of FIG. 1). Structural attributes may assist with edge detection, local orientation and dip of seismic reflectors, continuity of seismic events (e.g., parallel to estimated bedding orientation), etc. As an example, an edge may be defined as a discontinuity in horizontal amplitude continuity within seismic data and correspond to a fault, a fracture, etc. Geometrical attributes may be spatial attributes and rely on multiple traces.

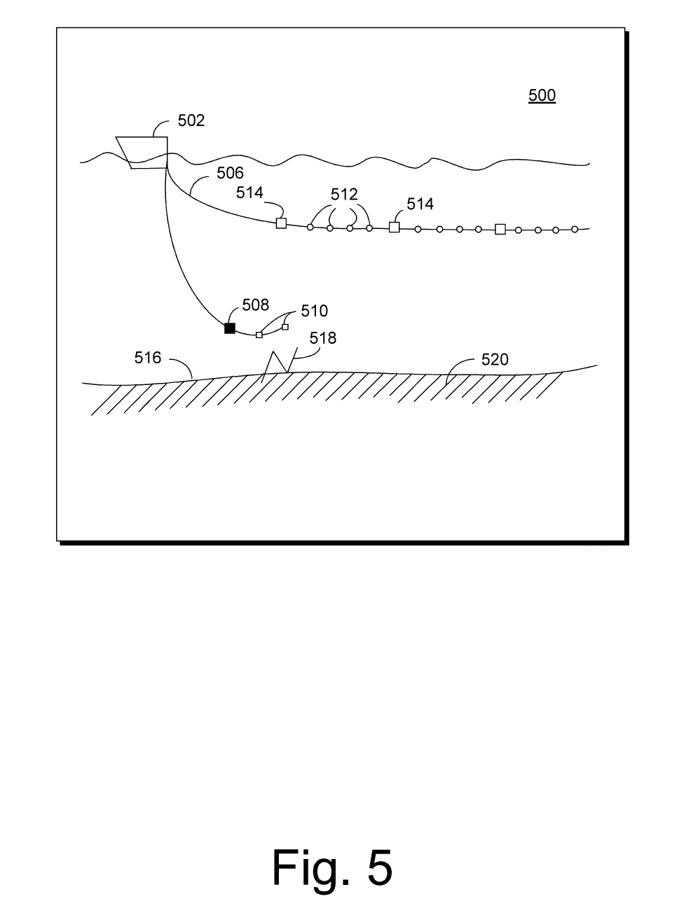

FIG. 5 illustrates an example of a marine electromagnetic survey system 500 in accordance with implementations of various technologies described herein. The electromagnetic survey system 500 may use controlled-source electromagnetic (CSEM) survey techniques, but other electromagnetic survey techniques may also be used. Marine electromagnetic surveying may be performed by a survey vessel 502 that moves in a predetermined pattern along the surface of a body of water such as a lake or the ocean. The survey vessel 502 is configured to pull a towfish (an electric source) 508, which is connected to a pair of electrodes 510. During the survey, the vessel may stop and remain stationary for a period of time during transmission.

At the source 508, a controlled electric current may be generated and sent through the electrodes 510 into the seawater. For instance, the electric current generated may be in the range between about 0.01 Hz and about 20 Hz. The current creates an electromagnetic field 518 in the subsurface 520 to be surveyed. The electromagnetic field 518 may also be generated by magneto-telluric currents instead of the source 508. The survey vessel 502 may also be configured to tow a sensor cable 506. The sensor cable 506 may be a marine towed cable. The sensor cable 506 may contain sensor housings 512, telemetry units 514 and current sensor electrodes 520. The sensor housings 512 may contain voltage potential electrodes for measuring the electromagnetic field 218 strength created in the subsurface area 520 during the surveying period. The current sensor electrodes 520 may be used to measure electric field strength in directions transverse to the direction of the sensor cable 506 (the y- and z-directions). The telemetry units 514 may contain circuitry configured to determine the electric field strength using the electric current measurements made by the current sensor electrodes 520. While a marine-based electromagnetic survey is described in regard to FIG. 5, a land-based electromagnetic survey may also be used in accordance with implementations of various techniques described herein.

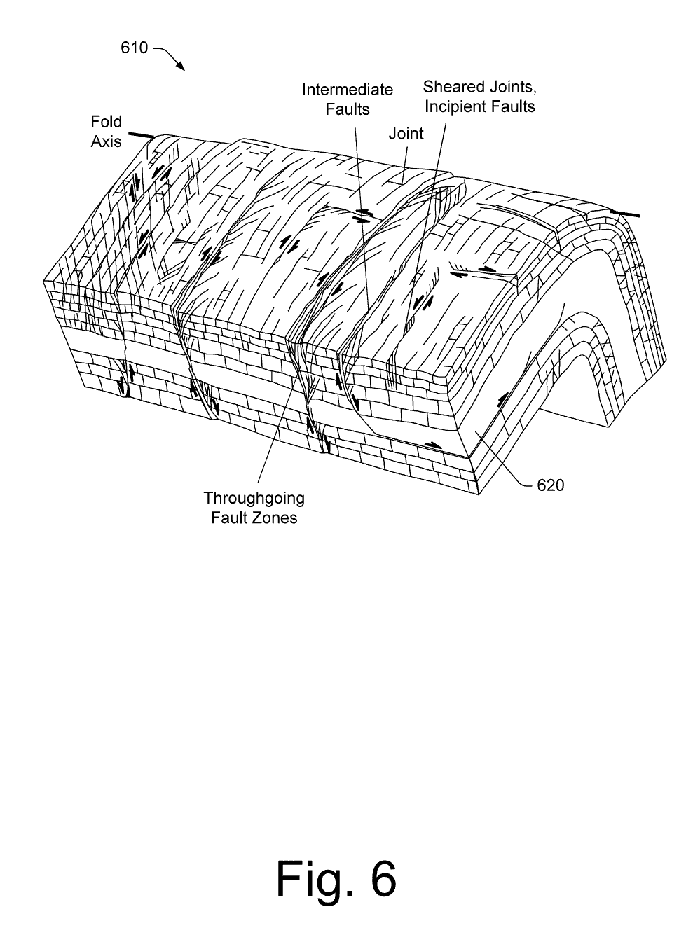

FIG. 6 shows an example of a geologic environment 610 that includes folds, faults and fractures along an anticline 620. In folded rocks, faults and fractures may be oriented, for example, parallel or perpendicular to a fold axis. Fractures may form in response to stress, joints may form by means of tensile stresses and faults may form by means of shear stresses. Deformation over time may cause fractures to extend and, for example, change direction of motion along fracture planes. Faults and fractures may be stratabound and, for example, confined to a single layer or they may be or become throughgoing where they may cross sedimentary sequences and span one or more formations within a geologic environment. Connectivity may range from isolated individual fractures to widely spaced fracture swarms or corridors, which may be interconnected fracture networks. As to exploration and development, horizontal wells may be drilled parallel to a fold axis, for example, to increase chance of intersecting fractures.

As an example, a method can enhance estimation of complex geology through measurement integration. Such a method may include receiving different types of measurements (e.g., seismic together with gravity and/or magnetic and/or electromagnetic measurements). Such a method may provide for output of information that can facilitate analysis of probability of exploration success.

As an example, a reservoir characterization can include estimating one or more petrophysical properties of a prospective hydrocarbon trap, for example, to reduce uncertainty of an interpretation. As an example, one or more frameworks may be used to implement a workflow or workflows that can include petrophysical joint inversion of seismic and electromagnetic (EM) attributes. Such a workflow or workflows may include outputting one or more values, for example, as estimate of a petrophysical model of a survey area.

As an example, a method can include performing petrophysical joint inversion (PJI) of seismic and EM attributes, for example, via Bayesian estimation that may include assuming that a Gaussian probability density function can apply to one or more model parameters and, for example, at least a portion of input data. Such a method may provide results in the form of 3D volumes of estimated rock properties (porosity, saturation, mineral content and anisotropic parameters). Thus, implementation of PJI may provide for a quantitative description of reservoir properties.

As an example, one or more algorithms may provide for one or more associated measures of uncertainty, which may be consistent with a petrophysical model and observations. As an example, rock physics models (e.g., isotropic and/or anisotropic) may be included in method, for example, as forward models to form a proper link between data input (e.g., seismic and EM attributes) petrophysical parameters (e.g., porosity, water saturation, mineral content, etc.).

Estimating oil and gas saturations can reduce risk of drilling of un-productive reservoirs. As an example, a method may include relating geophysical attributes to rock properties for prediction of reservoir properties. A method may include a deterministic approach and/or involve the use of statistics (e.g., to mitigate simplifications introduced by one or more rock physics models). As an example, a method can include seismic inversion attributes such as acoustic impedance (AI), Vₚ/Vₛ ratio, Poisson's ratio and density. Or, for example, an approach may include integration of seismic attributes (e.g., acoustic impedance, Vₚ/Vₛ) with EM attributes (e.g., consider a resistivity model obtained by controlled-source electromagnetic (CSEM) inversion). As an example, a method can include integrating different geophysical attributes to improve interpretation.

As an example, one or more technologies, techniques, etc. described in U.S. patent application Ser. No. 14/185,416, entitled “Joint Inversion of Geophysical Attributes”, which is incorporated by reference herein, may be implemented.

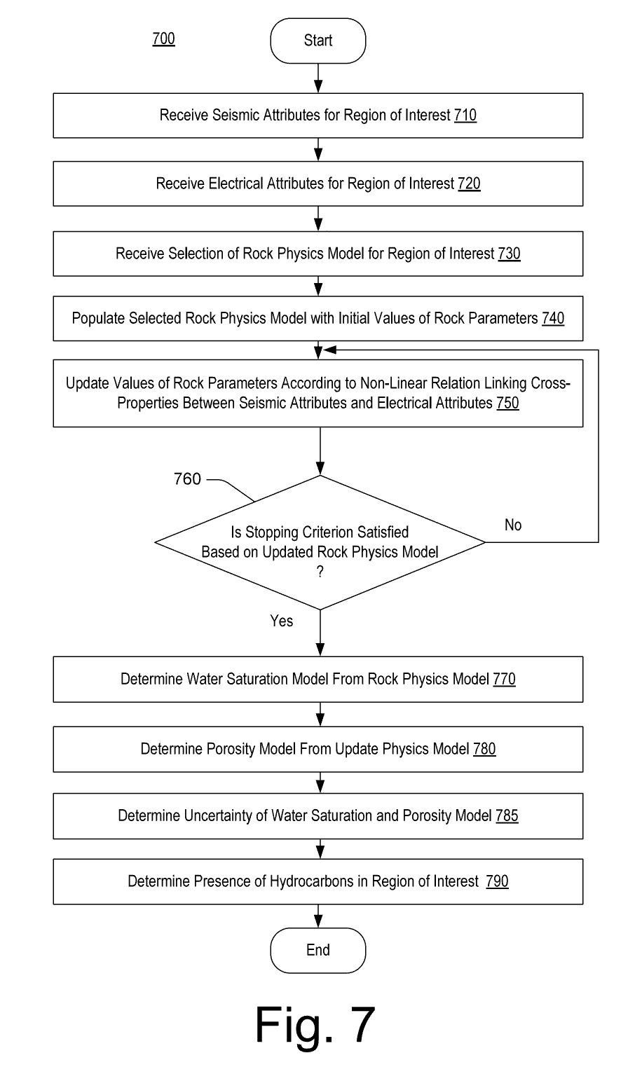

FIG. 7 illustrates a flow diagram of a method 700 for estimating rock parameters in accordance with various implementations described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted.

At block 710, seismic attributes for a region of interest are received. Examples of seismic attributes may include acoustic impedance, density, Vₚ/Vₛ (i.e., the ratio of a p-wave's velocity to that of the respective s-wave's velocity), Poisson's ratio, s-impedance or other anisotropic parameters of areas in a subsurface of the earth. The region of interest may include an area in the earth's subsurface encompassed by a seismic or other survey. The region of interest may be a physical region that is analyzed to predict reservoir properties, such as oil, gas or water saturation.

The seismic attributes may be obtained from a seismic data set (see, e.g., FIG. 1). Further, the seismic attributes may be the product of a transformation process called seismic inversion. In seismic inversion, raw seismic data acquired during a survey may undergo a data interpretation process to obtain geological depth information, such as the seismic attributes for the region of interest. Seismic inversion encompasses many different seismic data processes, which may be done pre-stack or post-stack, deterministically, randomly or using geostatistical methods. The science behind seismic inversion is that a recorded seismic trace may be modeled as the convolution of a wavelet and a reflection coefficient series with noise added in. Equation 1 demonstrates this relationship:

S(t)=R(t)*w(t)+n(t) Equation 1

where S(t) is a recorded seismic trace as a function of reflection time, R(t) is the reflection coefficient series, w(t) is the wavelet, n(t) is noise, and * is the convolution operator.

In one implementation, the seismic attributes received in block 710 may be arranged in a model or volume composed of cells that represent physical locations in the region of interest. Individual cells may include specific values for various seismic attributes that correspond to the cell's respective physical location. These individual cells may also include a measure of uncertainty associated with specific seismic attributes for that respective cell. In one case, the measured uncertainty may be the measured standard deviation calculated for the respective seismic attribute.

At block 720, electrical attributes are received for the region of interest. Examples of electrical attributes may include resistivity, conductivity, or other electrical parameters. The electrical attributes may be obtained from raw electromagnetic (EM) data (e.g., electric field data and/or magnetic field data) acquired during an electromagnetic survey. Raw EM data may be collected by recording electromagnetic fields that pass beneath the earth's subsurface. While the raw EM data may be acquired using CSEM survey techniques, other electromagnetic survey techniques may be used as well. For instance, magnetotelluric (MT) surveying or DC electrical techniques, such as those regarding resistivity or magnetometric resistivity, may be used to determine electrical attributes for the region of interest. Through CSEM inversion or a similar type of electromagnetic inversion, the raw EM data may be transformed into a data set that shows electrical attributes such as resistivity, conductivity, or other EM properties of the mediums in the subsurface. This inversion may produce an EM data set that includes separate vertical and horizontal resistivity attributes for the region of interest. If isotropic media is assumed, either the horizontal or vertical resistivity components may be used as the basis for a specific electrical attribute. In one implementation, the electrical attributes may be obtained through a controlled-source electromagnetic anisotropic inversion of electromagnetic survey data for the region of interest.

In one implementation, the electrical attributes received in block 720 may be arranged in a model or volume composed of cells that represent physical locations in the region of interest. Individual cells may include specific values for various electrical attributes that correspond to the cell's respective physical location. These individual cells may also include a measure of uncertainty associated with specific electrical attributes for that respective cell. In one case, the measured uncertainty may be the measured standard deviation calculated for the respective electrical attribute.

At block 730, a selection of a rock physics model for the region of interest is received (i.e., “the selected rock physics model”). Various rock physics models are available and their efficacy may depend on the particular lithology of the sediments in the region of interest. The selected rock physics model may be an isotropic or anisotropic rock physics model, which may encompass anisotropic scenarios. One example of a selected rock physics model may include a forward model based on the Gassmann model and the second formulation of the Archie model. The selected rock physics model may represent constitutive equations that link rock properties with well-log measurements through specific cross properties.

Cross-properties are parameters relating various heterogeneous well-log measurements to each other (e.g., data from a sonic log, a resistivity log, a gravimetric log, etc.), where heterogeneous may refer to measurements obtained through different types of surveying (e.g., measurements obtained through seismic surveying versus electromagnetic surveying). Based on various cross-property relations, specific properties obtained from electrical measurements (i.e., the resistivity log), density measurements (i.e., the gravimetric log) and elastic measurements (i.e., the sonic or seismic log) of physical mediums may overlap. Using these cross-property relations may prove ideal, for instance, when seismic velocity measurements can be more easily collected for a physical region than conductivity measurements for that same region. In that case, the conductivity for the physical region may be obtained from a cross-property relation with the seismic velocity as recorded for that same region. Examples of cross-property parameters may include rock porosity φ, water saturation S_{w}, oil saturation Sₒ and gas saturation S_{g}.

At block 740, the selected rock physics model may be populated with initial values of rock parameters (i.e., “the populated rock physics model”) as used by the selected rock physics model. In calculating values for the selected rock physics model, for instance, realistic starting values may be obtained for both the porosity and water saturation throughout the region of interest. Furthermore, geophysical boundaries of rocks parameters (i.e., the physical regions with particular rock parameter values) that correspond to seismic attributes (from block 710) or to electrical attributes (from block 720) may be determined. The initial values may be determined using various analytical micromechanical methods, such as the Hashin-Shtrikman model. With the Hashin-Shtrikman model, upper or lower bounds may be determined for specific rock parameters, such as those for elastic moduli (e.g., bulk modulus, shear modulus, bulk density, etc.) or tensors. The populated rock model may be referred to as the prior model mₚᵣᵢₒᵣ, as used in block 750. The uncertainty of the prior model may be referred to as C_{M}, as used in block 750.

In one implementation, the selected rock physics model may be calibrated to achieve realistic starting values. One method of calibration may include analyzing well logs available for the region of interest. The selected rock physics model may also be calibrated through the analysis of scatter plots that explain specific relations between seismic attributes and electrical attributes (e.g., Poisson's ratio versus resistivity). Further, the calibration may be performed by comparing specific relations between seismic attributes themselves (e.g., acoustic impedance versus Poisson's ratio).

To calculate rock property values (i.e., initial values or updated values) for the selected rock physics model, several specific relations or constitutive equations may be used. Isotropic media may be assumed for the constitutive equations, but this approach may also be used for anisotropic media. For instance, the compressional velocity, Vₚ, in homogeneous, isotropic, elastic media may be predicted using the following equation:

$${V}_{p} = \sqrt{\frac{{K}_{G} + \frac{4}{3} μ}{ρ}} \qquad Equation 2$$

where ρ is the bulk density of a composite medium, μ is the effective shear modulus of the porous rock, and K_{G} is the effective bulk modulus of the saturated rock, which may be calculated using the Gassmann model. The Gassmann model is defined by the following equation:

$${K}_{G} = \frac{{K}_{s} - {K}_{m} + φ \cdot {K}_{m} \cdot \frac{{K}_{s}}{{K}_{f}} - 1}{1 - φ - \frac{{K}_{m}}{{K}_{s}} + φ \cdot \frac{{K}_{s}}{{K}_{f}}} \qquad Equation 3$$

where φ is the total porosity of the medium, Kₛ is the bulk modulus of mineral content that makes up the rock, K_{f} is the effective bulk modulus of the fluid phase, and Kₘ is the effective bulk modulus of dry porous rock predicted by the Krief model. Kₘ may be defined using the following equation:

$${K}_{m} = {K}_{s} \cdot {( 1 - φ )}^{\frac{A}{1 - φ}} \qquad Equation 4$$

where A is the empirical parameter with ‘3’ being the most common value of the empirical parameter. The effective bulk modulus of the fluid phase, K_{f}, may be predicted by Wood's formula (three-phase fluid), which is defined in the following equation:

$${K}_{f} = {( \frac{{S}_{w}}{{K}_{w}} + \frac{{S}_{g}}{{K}_{g}} + \frac{{S}_{o}}{{K}_{o}} )}^{- 1} \qquad Equation 5$$

Returning to Equation 2, the effective shear modulus of porous rock, μ, may be obtained using the Krief model that is defined in the following equation:

$$μ = {μ}_{s} \cdot {( 1 - φ )}^{\frac{A}{1 - φ}} \qquad Equation 6$$

where μₛ is the shear modulus of the mineral content that makes up the rock.

To calculate the bulk density of a composite medium, ρ, the volumetric average (three-phase fluid) may be used as defined by the following equation:

ρ=(1−φ)·ρₛ+φ·(S_{w}ρ_{w}+Sₒρₒ+S_{g}ρ_{g}) Equation 7

In regard to Equation 7, ρₛ is the mean bulk density (also called grain density) of a solid matrix material, ρ_{w} is the density of water, ρₒ is the density of oil and ρ_{g} is the density of gas.

To calculate the electrical resistivity, the Archie model's second formulation may be used as defined by the following equation:

R=R_{w}·S_{w}⁻ⁿ·φ^{-m} Equation 8

where R_{w} is the water resistivity, S_{w} is the water saturation, m is the cementation exponent, and n is the saturation exponent.

Geophysical attributes (e.g., seismic attributes and electrical attributes) and the cross-property parameters may be linked using the rock physics models (i.e., Krief and Gassman models) described above, which results in the following equations:

$$\begin{matrix}{AI}_{AVO} = {V}_{P} \cdot ρ = \sqrt{\frac{{K}_{G} ( φ , Sw ) + \frac{4}{3} {μ}_{m} ( φ )}{ρ ( φ , Sw )}} \cdot ρ ( φ , Sw ) & Equation 9 \\ {R}_{CSEM} = R ( φ , Sw ) & Equation 10\end{matrix}$$

AI_{AVO} of Equation 9 is the acoustic impedance based on amplitude versus offset (AVO), and R_{CSEM} of Equation 10 is the resistivity determined by CSEM inversion.

The populated rock physics model may have a grid that matches the cells of the seismic attributes and the electrical attributes from blocks 710 and 720, respectively. In one implementation, since CSEM inversion may produce an electromagnetic data set with a resolution that is less than a seismic data set produced by seismic inversion, a transverse resistance principle may mitigate this limitation through a two phase process. First, a resistive anomaly (i.e., R_{anomaly}) which results from the CSEM inversion may be defined as: R_{anomaly}=R_{CSEM}−R_{back}. In this formulation, R_{back} is a background resistivity model, which may be based on well logs and/or geological information. Secondly, by applying the transverse resistive principle to the R_{anomaly}, the resistive anomaly may be bound within the geological boundaries that are supposed to include hydrocarbon.

At block 750, the current rock physics model, mₖ, is updated according to a non-linear relation that links cross-property parameters between the seismic attributes and the electrical attributes. Where the process reaches block 750 for the first time, the current rock physics model may be the same one as the populated rock physics model from block 740. For instance, the following equation may be used to describe the non-linear relation:

d=g(m) Equation 11

In Equation 11, the vector m defines unknown model parameters in the model space m=[φ, S_{w}]^{T} (e.g., porosity and water saturation in a bi-phase configuration, though in other implementations different or additional cross-properties may be used, such as in tri-phase cases), while the d vector represents the geophysical measured attributes or input data such that d=[AI_{AVO}, R_{CSEM}]^{T} (i.e., acoustic impedance and resistivity). The function g is the nonlinear relation. In accordance with Bayesian theory, the initial values of rock parameters as obtained in block 740 may be described by the prior model mₚᵣᵢₒᵣ (i.e., the populated rock physics model) and by the covariance matrix C_{M} that takes into account the prior model's uncertainties. The uncertainty associated with the observed data (i.e., the survey data used for the seismic attributes or electrical attributes) is captured by C_{D}, which is a data covariance matrix. A Gaussian probability distribution may be assumed for both the unknown model parameters m and the input data d. The Jacobian matrix Gₖ may include the derivatives of the selected rock physics model equation with respect to the current values of the unknown model parameters.

Keeping with block 750, the current model mₖ may be updated iteratively by calculating new rock parameters values using a solution of the inverse problem to Equation 11. The solution may be obtained through an iterative procedure that linearizes the selected rock physics model (e.g., the Gassman model and Archie model) around the current model mₖ to obtain a new model or updated model mₖ₊₁. The solution may be expressed in the closed-form as defined by the following equation:

mₖ₊₁=mₚᵣᵢₒᵣ−[Gₖ^{T}C_{d}⁻¹Gₖ+C_{M}⁻¹]⁻¹Gₖ^{T}C_{d}⁻¹·[(g(mₖ)−d)−Gₖ(mₖ−mₚᵣᵢₒᵣ)] Equation 12

With individual iterations of Equation 12, the Jacobian matrix Gₖ may be updated accordingly to produce the updated model mₖ₊₁.

At block 760, the updated model from block 750 is compared with a stopping criterion. For instance, the iterative algorithm of block 760 may stop when the following inequality is satisfied:

∥m_{i,k+1}−m_{i,k}∥<ε ∀ᵢ=1, . . . L Equation 13

Where L represents the number of cells in the selected rock physics model and ε is a predetermined value that specifies the stopping criterion. The stopping criterion may be a set of values where the posterior probability density of the selected model is maximized. Further, the stopping criterion may be where the values of the updated rock model mₖ₊₁ converge to a local optimum. If the stopping criterion has been satisfied, the process may proceed to block 770. If the stopping criterion has not been satisfied, the process may return to block 750.

At block 770, a water saturation model is determined from the updated model produced in block 760. The water saturation model may include the values of S_{w} obtained for mₚₒₛₜ (or the final mₖ₊₁ used in block 760). The water saturation model may have L number of cells, or the same number of cells as used in the selected rock physics model.

At block 780, a porosity model is determined from the updated model produced in block 760. The porosity model may include the values of φ obtained for mₚₒₛₜ. The porosity model may have L number of cells, or the same number of cells as used in the selected rock physics model.

At block 785, an amount of uncertainty regarding the water saturation model and the porosity model is determined or estimated. The estimated uncertainty of the solution of the inverse problem to Equation 11 may be calculated from the posterior covariance matrix of the model mₚₒₛₜ which is defined in the following equation:

C_{M,post}=(Gₖ^{T}C_{d}⁻¹Gₖ+C_{M}⁻¹)⁻¹ Equation 14

The estimated uncertainty of the final parameters of mₚₒₛₜ may be the measured standard deviation for the respective final rock parameters. The estimated uncertainty may provide a measure of confidence in the accuracy of the final updated model.

At block 790, the presence of hydrocarbons is determined for the region of interest. For instance, a petrophysical model may be estimated for the region of interest. The petrophysical model may be based on the water saturation model from block 770 or the porosity model from block 780. The petrophysical model may include various petrophysical properties that describe the region of interest such as the amount of shale (Vₛₕₐₗₑ), the elastic moduli of composite rock or the density of the solid phase of rock. The elastic moduli of composite rock may include the bulk modulus or the shear modulus of the composite rock. The uncertainty from block 785 may also be used in this hydrocarbon determination or for estimating the petrophysical model. A degree of confidence or uncertainty associated with the presence of hydrocarbons may be calculated as well. An accurate hydrocarbon determination may prevent the drilling of costly unproductive wells.

In one implementation, method 700 may be used with input data of physical attributes besides seismic attributes or electrical attributes. Such physical attributes may be obtained from surveys that use sonar, gravimetric, or satellite tomographic imaging. For instance, density attributes may be obtained for a region of interest using a gravimetric survey. Physical attributes from two different survey-types may be used with a non-linear relation similar to the one described in block 350 to update a respective model. A physical parameter model, such as a water saturation model or a porosity model, may then be obtained for the region of interest. The region of interest may also be a region of human tissue, plant tissue, or any other multi-dimension region of interest. A physics model specific to the region of interest may be used instead of a rock physics model.

In accordance with some embodiments, a method is performed that includes receiving seismic attributes regarding a region of interest in a subsurface of the earth. The method may receive electrical attributes regarding the region of interest. The method may receive a selection of a rock physics model for the region of interest. The method may calculate values of rock parameters for the selected rock physics model using a nonlinear relation that links cross-properties between the seismic attributes and the electrical attributes for the region of interest. The method may determine the presence of hydrocarbon deposits in the region of interest using the calculated values.

In one implementation, the seismic attributes may include acoustic impedance, density, Poisson's ratio, s-wave impedance or anisotropic parameters. The seismic attributes may be obtained through seismic inversion of seismic survey data for the region of interest. The electrical attributes may include conductivity or resistivity parameters. The electrical attributes may be obtained through a controlled-source electromagnetic (CSEM) inversion of electromagnetic survey data for the region of interest. The cross-properties may include rock porosity, water saturation, gas saturation or oil saturation. The method may determine a water saturation model for the region of interest using the calculated values. The method may calculate an amount of uncertainty for the water saturation model. The amount of uncertainty of the water saturation model may include the standard deviation of respective cross-property parameters of the calculated values for the selected rock physics model. The method may determine a porosity model for the region of interest using the calculated values for the selected rock physics model. The method may calculate an amount of uncertainty for the porosity model. Calculating values for the selected rock physics model may include iteratively updating the calculated values of the selected rock physics model using the nonlinear relation. The method may determine whether the calculated values for the selected rock physics model have reached a stopping criterion. The stopping criterion may be a predetermined value that maximizes the posterior probability density of the values in the selected rock physics model.

As an example, a stochastic method may be implemented to estimate a petrophysical model of a survey area in terms of, for example, porosity, fluid saturation, mineral content and anisotropic parameters. In such an example, the method can include exploiting simultaneously the strength of heterogeneous geophysical attributes to reduce the uncertainty of the result within the probabilistic framework provided by the Bayesian theory. Further, it may allow for estimating the output uncertainty related to the result.

As an example, a first part of a PJI can address calibration of a rock model that may be defined by the following set of parameters: Bulk modulus, K of the solid and fluid phases; shear modulus, p of the solid phases; Bulk density, p of the solid and fluid phases; and Rock model parameters, depending on the rock physics model is used.

As an example, a rock model may be calibrated by passing through an analysis of well logs available within a survey area. For example, the Hashin-Shtrikman model may be used to define the physical boundaries of previous quantities. If well logs are not available, a rock model may be calibrated through the analysis of the scatter plots explaining relations between, for example, seismic attributes and resistivity, (e.g., Poisson's ratio versus resistivity), and between the seismic attributes themselves, (e.g., acoustic impedance versus Poisson's ratio). In such an approach, a representative rock model template may be provided for a particular survey area to discriminate main rock families and to suggest realistic starting values for both porosity and water saturation and the volume of shale.

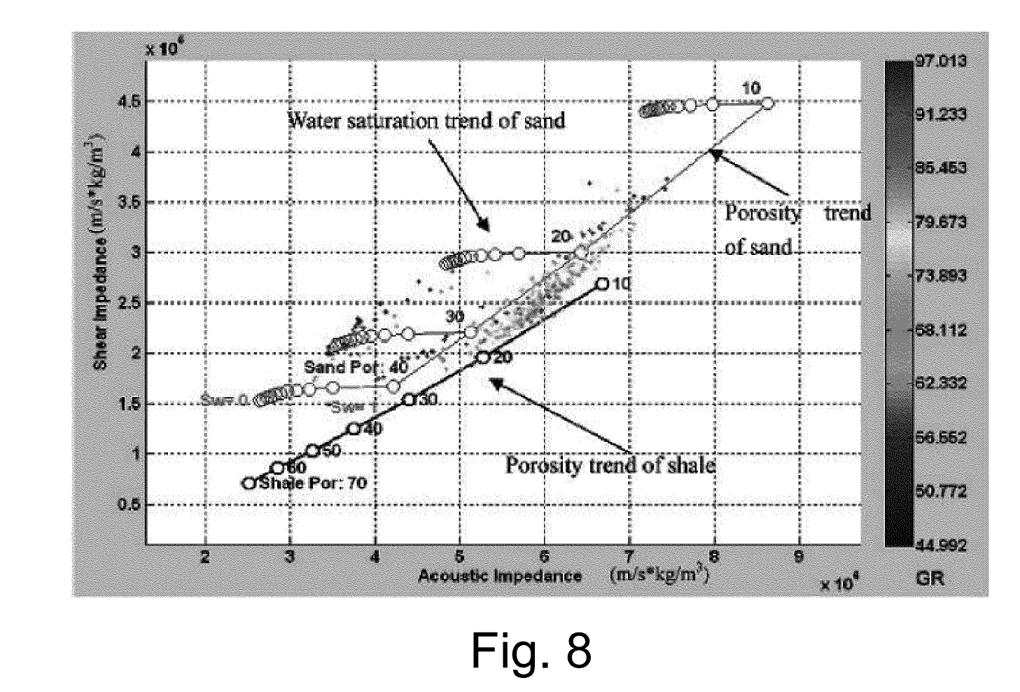

FIG. 8 shows an example plot of shear impedance versus acoustic impedance for sand and shale (see, e.g., Chi et al., “Lithology and fluid differentiation using rock physics template”, The Leading Edge, pp. 1424-1428 (2009), which is incorporated by reference herein). As an example, such information may provide for formulation of a template (e.g., a rock template).

Geologic formations can include rock, which may be characterized by, for example, porosity values and by permeability values. Porosity may be defined as a percentage of volume occupied by pores, void space, volume within rock that can include fluid, etc. Permeability may be defined as an ability to transmit fluid, measurement of an ability to transmit fluid, etc.

The term “effective porosity” may refer to interconnected pore volume in rock, for example, that may contribute to fluid flow in a formation. As effective porosity aims to exclude isolated pores, effective porosity may be less than total porosity. As an example, a shale formation may have relatively high total porosity yet relatively low permeability due to how shale is structured within the formation.

As an example, shale may be formed by consolidation of clay- and silt-sized particles into thin, relatively impermeable layers. In such an example, the layers may be laterally extensive and form caprock. Caprock may be defined as relatively impermeable rock that forms a barrier or seal with respect to reservoir rock such that fluid does not readily migrate beyond the reservoir rock. As an example, the permeability of caprock capable of retaining fluids through geologic time may be of the order of about 10⁻⁶ to about 10⁻⁸ D (darcies).

The term “shale” may refer to one or more types of shales that may be characterized, for example, based on lithology, etc. In shale gas formations, gas storage and flow may be related to combinations of different geophysical processes. For example, regarding storage, natural gas may be stored as compressed gas in pores and fractures, as adsorbed gas (e.g., adsorbed onto organic matter), and as soluble gas in solid organic materials.

Gas migration and production processes in gas shale sediments can occur, for example, at different physical scales. As an example, production in a newly drilled wellbore may be via large pores through a fracture network and then later in time via smaller pores. As an example, during reservoir depletion, thermodynamic equilibrium among kerogen, clay and the gas phase in pores can change, for example, where gas begins to desorb from kerogen exposed to a pore network.

Sedimentary organic matter tends to have a high sorption capacity for hydrocarbons (e.g., adsorption and absorption processes). Such capacity may depend on factors such as, for example, organic matter type, thermal maturity (e.g., high maturity may improve retention) and organic matter chemical composition. As an example, a model may characterize a formation such that a higher total organic content corresponds to a higher sorption capacity.

With respect to a shale formation that includes hydrocarbons (e.g., a hydrocarbon reservoir), its hydrocarbon producing potential may depend on various factors such as, for example, thickness and extent, organic content, thermal maturity, depth and pressure, fluid saturations, permeability, etc. As an example, a shale formation that includes gas (e.g., a gas reservoir) may include nanodarcy matrix permeability (e.g., of the order of 10⁻⁹ D) and narrow, calcite-sealed natural fractures. In such an example, technologies such as stimulation treatment may be applied in an effort to produce gas from the shale formation, for example, to create new, artificial fractures, to stimulate existing natural fractures (e.g., reactivate calcite-sealed natural fractures), etc.

Shale may vary by, for example, one or more of mineralogical characteristics, formation grain sizes, organic contents, rock fissility, etc. Attention to such factors may aid in designing an appropriate stimulation treatment. For example, an evaluation process may include well construction (e.g., drilling one or more vertical, horizontal or deviated wells), sample analysis (e.g., for geomechanical and geochemical properties), open-hole logs (e.g., petrophysical log models) and post-fracture evaluation (e.g., production logs). Effectiveness of a stimulation treatment (e.g., treatments, stages of treatments, etc., may determine flow mechanism(s), well performance results, etc.

As an example, a stimulation treatment may include pumping fluid into a formation via a wellbore at pressure and rate sufficient to cause a fracture to open. Such a fracture may be vertical and include wings that extend away from the wellbore, for example, in opposing directions according to natural stresses within the formation. As an example, proppant (e.g., sand, etc.) may be mixed with treatment fluid to deposit the proppant in the generated fractures in an effort to maintain fracture width over at least a portion of a generated fracture. For example, a generated fracture may have a length of about 500 ft extending from a wellbore where proppant maintains a desirable fracture width over about the first 250 ft of the generated fracture.

In a stimulated shale gas formation, fracturing may be applied over a region deemed a “drainage area” (e.g., consider at least one well with at least one artificial fracture), for example, according to a development plan. In such a formation, gas pressure (e.g., within the formation's “matrix”) may be higher than in generated fractures of the drainage area such that gas flows from the matrix to the generated fractures and onto a wellbore. During production of the gas, gas pressure in a drainage area tends to decrease (e.g., decreasing the driving force for fluid flow, for example, per Darcy's law, Navier-Stokes equations, etc.). As an example, gas production from a drainage area may continue for decades; however, the predictability of decades long production (e.g., a production forecast) can depend on many factors, some of which may be uncertain (e.g., unknown, unknowable, estimated with probability bounds, etc.).

Various shale gas formations have and are producing gas economically, which has widened interest gas production in other areas. For example, several shale gas exploration projects are under-way in diverse regions of the world, including Europe and Africa. However, a lack of understanding of various elements controlling well productivity, and limitations of available tools to adequately characterize a shale gas formation and forecast production from wells drilled therein, can make it more difficult to predict likely commercial value of a project. Factors that may impact a value assessment may include, for example, drilling costs, associated number of wells to develop a shale gas region, production return that each well can deliver, etc.

As an example, a method may include estimating properties using inversion and formulating a workflow for generating or activating fractures in a region that may include, for example, shale and/or sand. As an example, a method may include dynamic input of information, for example, as information may be acquired during a stimulation treatment, after a stimulation treatment, etc. As an example, a stimulation treatment may be performed in stages. In such an example, stage by stage analysis may be performed where, for example, an analysis after one stage may be used to design a treatment for a subsequent stage.

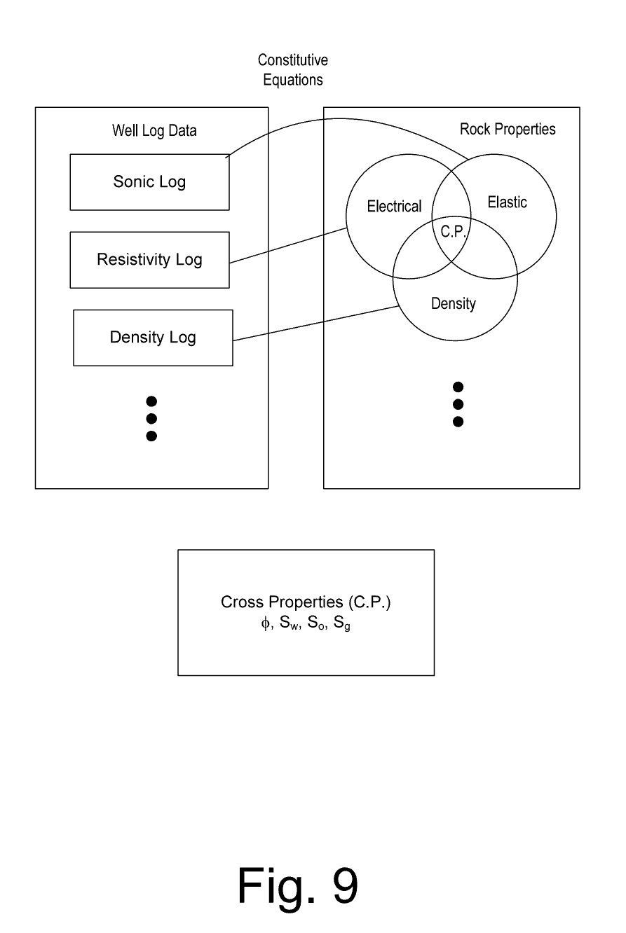

As an example, a rock cross property approach may be implemented for integrating heterogeneous measurements. In such an example, a method can include defining constitutive equations that link rock properties with well-log measurements. For example, FIG. 9 shows an example of an approach that links measurements to properties via various constitutive equations (see, e.g., Dell'Aversana P., Bernasconi G., Miotti F. and Rovetta D. 2011. Joint inversion of rock properties from sonic, resistivity and density well-log measurements. Geophysical Prospecting 59, 1144-1154, which is incorporated by reference herein). As an example, a method may include assuming isotropic media and/or considering anisotropic media. As an example, well-log data may be processed to derive subsurface physical parameters (e.g., rock porosity, fluid saturations and permeability). Such an approach may include selection and inversion of constitutive equations that link rock parameters and geophysical measurements. As an example, a set of rock properties (e.g., cross-properties) that influence different measurements can provide for reducing ambiguities of an interpretation. As an example, a Bayesian joint inversion procedure that can control conditioning problems may be implemented to account for input data and model uncertainty and to provide a confidence interval for a solution.

Various rock physics models are available where their efficacy can depend on particular lithology of sediments. As an example, to predict compressional velocity, consider the following relation:

$${V}_{p} = \sqrt{\frac{{K}_{G} + \frac{4}{3} μ}{ρ}} ,$$

where K_{G} is the effective bulk modulus of the saturated rock, defined by the generalized Gassmann model. Below is a general formulation of the generalized Gassmann model:

$${K}_{sat} = {\sum }_{i = 1}^{n - 1} {K}_{{m}_{i}} + {{[ {\sum }_{i = 1}^{n - 1} ( \frac{{φ}_{i}}{1 - {φ}_{n}} - \frac{{K}_{{m}_{i}}}{{K}_{i}} ) ]}^{2} [ {\sum }_{i = 1}^{n - 1} ( \frac{{φ}_{i}}{{K}_{i}} - \frac{{K}_{{m}_{i}}}{{K}_{i}^{2}} ) + \frac{{φ}_{n}}{{K}_{n}} ]}^{- 1}$$

$${K}_{{m}_{i}} = \frac{{φ}_{i} {K}_{HS}}{{\sum }_{i = 1}^{n - 1} {φ}_{i} {K}_{i}} {K}_{i} ( 1 - β )$$

where:

Kᵢ, bulk modulus of the i-th minerals making up the rock

Kₘᵢ, dry rock bulk modulus of the i-th mineral in the composite medium, (m denotes the matrix)

φᵢ, solid phases for i=1 . . . n−1

φₙ, porosity

β, Biot parameter, which can be expressed by the following models: Pride and Lee, Nur and Krief

K_{HS}, Average of the upper and lower bounds for the bulk modulus calculated as

$$\frac{{K}^{+} + {K}^{-}}{2}$$

Kₙ: effective bulk modulus of the fluid phase predicted by Wood's formula (three-phase fluid):

$${K}_{f} = {( \frac{{S}_{w}}{{K}_{w}} + \frac{{S}_{g}}{{K}_{g}} + \frac{{S}_{o}}{{K}_{o}} )}^{- 1}$$

The upper and lower bounds K_{HS} may be related to the saturated bulk modulus. As an example, an approach may consider various formulations such as a formulation defined by the Hashin Shtrikman rock model:

$${K}_{HS}^{\pm } = {K}_{1} + {\frac{{φ}_{2}}{1 - {φ}_{n}} [ {( {K}_{2} - {K}_{1} )}^{- 1} + \frac{{φ}_{1}}{1 - {φ}_{n}} {( {K}_{1} + \frac{4}{3} {μ}_{1} )}^{- 1} ]}^{- 1}$$

As an example, an approach may include such a formulation (e.g., or modification thereof) to calculate shear modulus of a composite medium, made by, for example, shale and sandstone. In such an example, given the shear modulus, Vₚ and Vₛ (shear velocity) may be obtained by applying the following formulae:

$${V}_{p} = \sqrt{\frac{{K}_{G} + \frac{4}{3} μ}{ρ}}$$

$${V}_{s} = \sqrt{\frac{μ}{ρ}}$$

The composite density may be defined by the following volumetric average (three-phase fluid) in a multilithology scenario (e.g., consider a multi-mineral scenario). For example, in shale and sand lithologies, consider a formulation:

ρ=(1−φ)·(V_{sand}ρ_{sand}+Vₛₕₐₗₑρₛₕₐₗₑ)+φ·(S_{w}ρ_{w}+Sₒ,ρₒ+S_{g}ρ_{g}),

To address the electrical resistivity, as an example, the Simandoux model may be used:

R=(F⁻¹·σ_{w}+Vₛₕ·σₛₕₐₗₑ)⁻¹,

where:

σ_{w}, water conductivity

σₛₕ, shale conductivity

F, Formation factor that is function of S_{w}/(water saturation), porosity, m and n empirical coefficients, F=f(S_{w},φ,m,n).

Vₛₕ, shale mineral fraction.

Prior rock models may represent constitutive equations that are able to constrain an inverse problem, for example, by providing a petrophysical model that conforms to the physics of the phenomenon.

As an example, a method may consider as input data:

Seismic attributes from seismic AVO inversion
acoustic impedance, density, Poisson's ratio, s-impedance and anisotropic parameters.

Electrical attributes from anisotropic CSEM inversion
vertical resistivity, horizontal resistivity, anisotropic parameters.

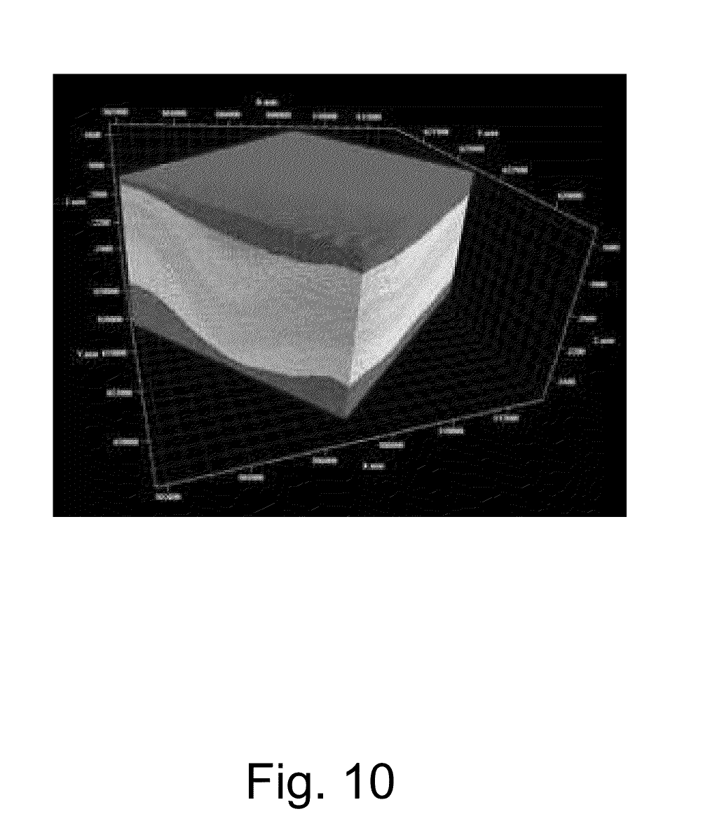

As an example, models may be defined within a grid in a manner that can assure consistency, for example, as to number of cells. For example, FIG. 10 shows an example of 3D input data (e.g., acoustic impedance, shear impedance and electrical resistivity).

As a CSEM inversion may produce a low-resolution model when compared to a seismic model, the transverse resistance principle may be applied to mitigation. For example, consider an approach as follows; first, derive the resistive anomaly within the model resulting from the CSEM inversion as: R_{anomaly}=R_{CSEM}−R_{back} where R_{back} is a background resistivity model, which may be generally defined based on well logs and/or geological information. Second, the approach may include, by applying the transverse resistive principle to R_{anomaly}, bind the resistive anomaly within the geological boundaries that are supposed to contain hydrocarbon.

As an example, linking between input data that are the geophysical attributes (e.g., acoustic impedance, shear impedance and electrical resistivity) and the petrophysical parameters (e.g., porosity, water saturation and volume of shale) can pass through rock physics models (e.g., as introduced above), for example, using formulations such as:

$${AI}_{AVO} = {V}_{P} \cdot ρ = \sqrt{\frac{{K}_{G} ( φ , Sw , Vsh ) + \frac{4}{3} {μ}_{m} ( φ )}{ρ ( φ , Sw , Vsh )}} \cdot ρ ( φ , Sw , Vsh ) , \\ {IS}_{AVO} = {V}_{S} \cdot ρ = \sqrt{\frac{{μ}_{m} ( φ )}{ρ ( φ , Sw , Vsh )}} \cdot ρ ( φ , Sw , Vsh ) , \\ {R}_{CSEM} = R ( φ , Sw , Vsh ) ,$$

In the foregoing example, three equations are given, one for acoustic impedance, one for shear impedance and one for electrical resistivity. Such equations act to link attributes and petrophysical parameters. As indicated, velocities can be included, which may pertain to one or more velocity models. While the foregoing equations include volume of shale, such an approach may be applied to one or more other types of materials. As an example, an equation may include terms for sand and shale.

As an example, regarding modeling, an approach such as that of Tarantola (see, e.g., Tarantola A. 2005. Inverse Problem Theory, SIAM) for inverse problems may be implemented. As an example, consider a general non-linear relation linking model parameters to the input data as follows:

d=g(m),

In such a formulation, the vector m defines the unknown model parameters in the model space m=[φ,S_{w},Vₛₕ]^{T} (porosity, water saturation and volume of shale in the bi-phase configuration), while the d vector represents the input data d=[AI, IS, R]^{T} (acoustic impedance, shear impedance and electrical resistivity values).

According to the Bayesian theory, the state of information on the model parameters is described by the prior model mₚᵣᵢₒᵣ and by C_{M}, the covariance matrix that takes into account its uncertainties. The uncertainty associated with the observed data is captured by C_{D}, which is the data covariance matrix. As an example, it may be assumed that Gaussian probability distributions apply for both model parameters and data. As an example, a solution of the inverse problem may be obtained through an iterative procedure that linearizes the forward model around the current model mₖ and obtains a new model mₖ₊₁. At an individual iteration, the Jacobian matrix Gₖ that includes the derivatives of the forward model equation with respect to the current model parameters may be numerically updated. As an example, consider a closed-form solution as:

mₖ₊₁=mₚᵣᵢₒᵣ−[Gₖ^{T}C_{d}⁻¹Gₖ+C_{M}⁻¹]⁻¹Gₖ^{T}C_{d}⁻¹·[(g(mₖ)−d)−Gₖ(mₖ−mₚᵣᵢₒᵣ)],

As an example, a method may include sensitivity analysis and regularization of an inverse problem. As an example, an iterative algorithm may include one or more criteria to halt iterations, for example, consider:

∥m_{i,k+1}−m_{i,k}∥<ε ∀ᵢ=1, . . . L,

where L represents the number of cells forming the petrophysical model and & is the predefined value that specifies a stopping criterion. An estimated uncertainty of the solution may be derived by the posterior covariance matrix of the model C_{M,post} as:

C_{M,post}=(Gₖ^{T}C_{d}⁻¹Gₖ+C_{M}⁻¹)⁻¹,

Such an algorithm can provides also the C_{D,post}, that is the covariance matrix of the computed synthetic data. As an example, the main diagonal of the matrix can include the estimated variance for individual model parameters (e.g., porosity and water saturation). As an example, a procedure can include fitting bi-phases, three-phases fluid and/or multilithology scenarios. In a bi-phase configuration, such as water-gas, in shale-sand lithologies the explained procedure generates as result:

The porosity model

The water saturation model

The mineral content such as Vₛₕₐₗₑ and/or V_{sand} (volume of shale and volume of sand, respectively)

Uncertainty of the previous models represented by the estimation of the standard deviation

Anisotropic parameters (e.g., elastic and/or electric).

As an example, a method can address tri-phase cases and multilithology scenarios. As an example, a method may address shale, sandstone or shale and sandstone. As an example, a method may address one or more other types of materials (e.g., rocks other than shale and sandstone, optionally including one of shale or sandstone).

As an example, a method can include receiving well log data to calibrate a representative rock model for a survey area, for example, to improve a result.

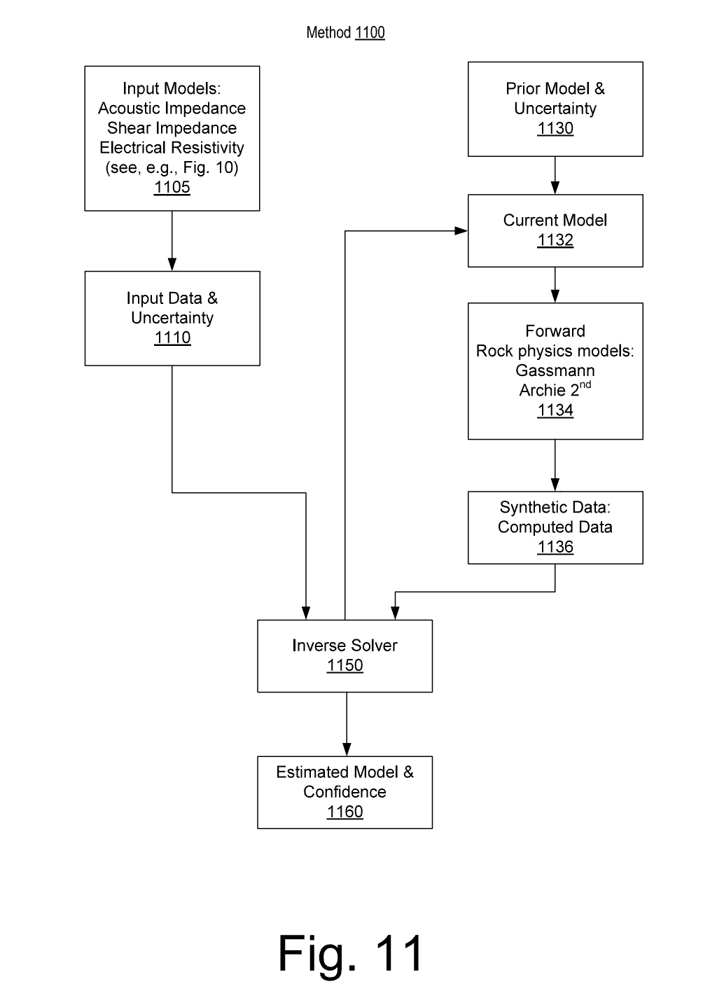

FIG. 11 shows an example of a method 1100, which may be a workflow or part of a workflow. As shown, model information is provided per a model input block 1105 (e.g., as to acoustic impedance, shear impedance and electrical resistivity). Such model information may be input along with other information to an input block 1110 of the method 1100. For example, the input block 1110 can include inputting input data and uncertainty information. As shown, the input block 1110 may output information to an inverse solver block 1150 (e.g., PJI).

As shown, the method 1100 can include a prior model and uncertainty information block 1130, a current model block 1132, a forward modeling block 1134 (e.g., with one or more rock physics models), and a data block 1136 (e.g., for synthetic data). As shown, the inverse solver block 1150 may operate via information from the input block 1110 and from the data block 1136. The inverse solver block 1150 may output an estimated model along with confidence information, for example, per an output block 1160. The method 1100 may operate in an iterative manner, for example, where output of the inverse solver block 1150 is received by the current model block 1132. As an example, an iteration may optionally include receiving at the inverse solver block 1150 information that may be additional information, for example, where the input block 1110 receives additional information. Accordingly, a method such as the method 1100 may be dynamic and optionally respond to receipt of information (e.g., to provide one or more additional estimates, iterations, etc.).

As an example, various techniques, technologies, etc. may support CSEM technology, for example, as an additional tool to be used in conjunction with seismic attributes to reduce uncertainty in prospect generation and identification. As an example, once prospects are identified, (e.g., with complimentary structural, stratigraphic and DHI's with CSEM resistivity indicators), PJI may be implemented as a quantifier for reservoir attributes, for example, to derive a more reliable petrophysical model.

As an example, a method can include receiving data associated with a multilithology geologic environment; and, based on at least a portion of the data, determining values for multiphase model parameters defined in a model space. Such a method may include formulating a covariance matrix, for example, where the covariance matrix accounts for uncertainties. As an example, a data covariance matrix may account for uncertainties in at least a portion of data.

As an example, a method can include implementing an inverse problem formulation: d=g(m), where d is a vector that represents data and where m is a vector that represents the multiphase model parameters defined in the model space. In such an example, the vector d that represents data may represent acoustic impedance data, shear impedance data and electrical resistivity data; and/or the vector m that represents the multiphase model parameters may represent porosity, water saturation and volume of shale.

As an example, a method can include solving an inverse problem. In such an example, the method may include implementing an iterative procedure that linearizes a forward model around a current model (mₖ) to obtain a new model (mₖ₊₁). In such an example, solving can include calculating values of a Jacobian matrix (Gₖ) that includes derivatives of the forward model with respect to parameters of the current model. A method may include estimating uncertainty of a solution using a posterior covariance matrix and, for example, estimating a covariance matrix of computed synthetic data.

As an example, a multilithology geologic environment can include at least shale. As an example, a multilithology geologic environment can include shale and sand.

As an example, a system can include a processor; memory operatively coupled to the processor; and one or more modules that include processor-executable instructions stored in the memory to instruct the system to receive data associated with a multilithology geologic environment; and, based on at least a portion of the data, determine values for multiphase model parameters defined in a model space. In such an example, instructions may instruct the system to perform joint inversion to determine the values. As an example, instructions may instruct the system to determine values via instructions to implement an inverse problem formulation: d=g(m), where d is a vector that represents data and where m is a vector that represents the multiphase model parameters defined in the model space.

As an example, one or more computer-readable storage media can include computer-executable instructions to instruct a computer to: receive data associated with a multilithology geologic environment; and, based on at least a portion of the data, determine values for multiphase model parameters defined in a model space. In such an example, instructions can be to receive seismic data and nonseismic data. As an example, instructions may be included to solve an inverse problem to determine the values.

As an example, a workflow may be associated with various computer-readable media (CRM) blocks. Such blocks generally include instructions suitable for execution by one or more processors (or cores) to instruct a computing device or system to perform one or more actions. As an example, a single medium may be configured with instructions to allow for, at least in part, performance of various actions of a workflow. As an example, a computer-readable medium (CRM) may be a computer-readable storage medium. As an example, blocks may be provided as one or more modules, for example, such as the one or more modules 270 of the system 250 of FIG. 2.

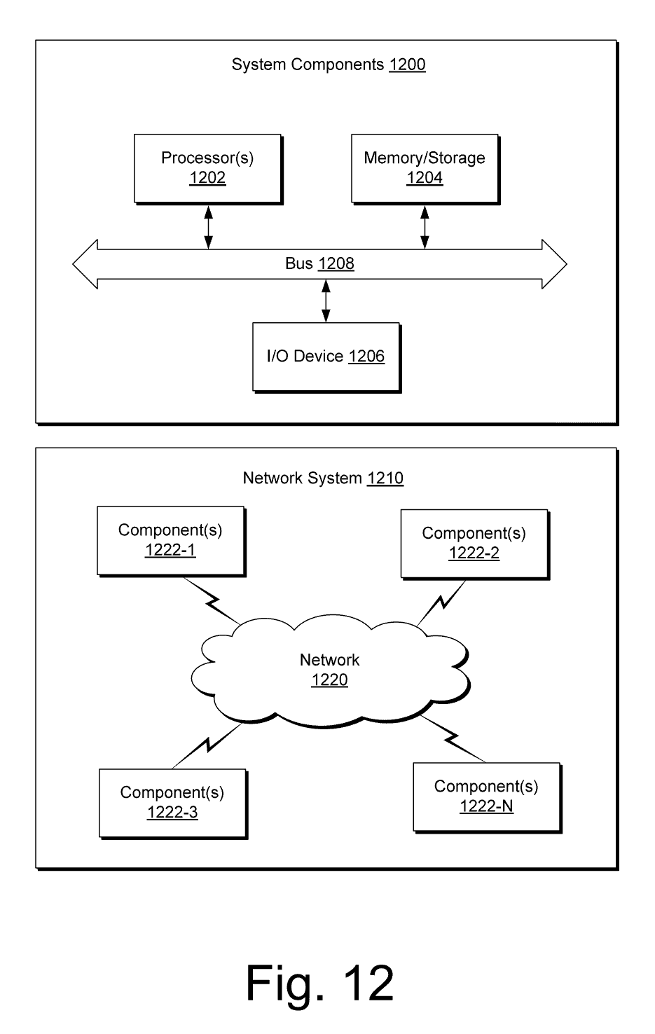

FIG. 12 shows components of an example of a computing system 1200 and an example of a networked system 1210. The system 1200 includes one or more processors 1202, memory and/or storage components 1204, one or more input and/or output devices 1206 and a bus 1208. In an example embodiment, instructions may be stored in one or more computer-readable media (e.g., memory/storage components 1204). Such instructions may be read by one or more processors (e.g., the processor(s) 1202) via a communication bus (e.g., the bus 1208), which may be wired or wireless. The one or more processors may execute such instructions to implement (wholly or in part) one or more attributes (e.g., as part of a method). A user may view output from and interact with a process via an I/O device (e.g., the device 1206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1210. The network system 1210 includes components 1222-1, 1222-2, 1222-3, . . . 1222-N. For example, the components 1222-1 may include the processor(s) 1202 while the component(s) 1222-3 may include memory accessible by the processor(s) 1202. Further, the component(s) 1202-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving data associated with a multilithology geologic environment; and
based on at least a portion of the data, determining values for multiphase model parameters defined in a model space.

2. The method of claim 1 wherein the determining comprises formulating a covariance matrix.

3. The method of claim 2 wherein the covariance matrix accounts for uncertainties.

4. The method of claim 1 wherein a data covariance matrix accounts for uncertainties in at least a portion of the data.

5. The method of claim 1 wherein the determining comprises implementing an inverse problem formulation:
d=g(m)
where d is a vector that represents data and where m is a vector that represents the multiphase model parameters defined in the model space.

6. The method of claim 5 wherein the vector d that represents data represents acoustic impedance data, shear impedance data and electrical resistivity data.

7. The method of claim 5 wherein the vector m that represents the multiphase model parameters represents porosity, water saturation and volume of shale.

8. The method of claim 1 wherein the determining comprises solving an inverse problem.

9. The method of claim 8 wherein the solving comprises implementing an iterative procedure that linearizes a forward model around a current model (mₖ) to obtain a new model (mₖ₊₁).

10. The method of claim 9 wherein the solving comprises calculating values of a Jacobian matrix (Gₖ) that comprises derivatives of the forward model with respect to parameters of the current model.

11. The method of claim 10 further comprising estimating uncertainty of a solution using a posterior covariance matrix.

12. The method of claim 11 further comprising estimating a covariance matrix of computed synthetic data.

13. The method of claim 1 wherein the multilithology geologic environment comprises at least shale.

14. The method of claim 1 wherein the multilithology geologic environment comprises shale and sand.

15. A system comprising:
a processor;
memory operatively coupled to the processor; and
one or more modules that comprise processor-executable instructions stored in the memory to instruct the system to
receive data associated with a multilithology geologic environment; and
based on at least a portion of the data, determine values for multiphase model parameters defined in a model space.

16. The system of claim 15 wherein the instructions to instruct the system comprises instruction to instruct the system to perform joint inversion to determine the values.

17. The system of claim 15 wherein the instructions to instruct the system to determine values comprise instructions to implement an inverse problem formulation:
d=g(m)
where d is a vector that represents data and where m is a vector that represents the multiphase model parameters defined in the model space.

18. One or more computer-readable storage media comprising computer-executable instructions to instruct a computer to:
receive data associated with a multilithology geologic environment; and
based on at least a portion of the data, determine values for multiphase model parameters defined in a model space.

19. The one or more computer-readable storage media of claim 18 comprising computer-executable instructions to receive seismic data and nonseismic data.

20. The one or more computer-readable storage media of claim 18 comprising computer-executable instructions to solve an inverse problem to determine the values.
